(19) United States
(12) Patent Application Publication
(10) Pub. No.: US 2026/0126004 A1
(43) Pub. Date: May 7, 2026

(54) SYSTEM AND METHOD FOR PRODUCING AMMONIA

(71) Applicant: Siemens Energy Global GmbH & Co. KG, München (DE)

(72) Inventors: Suhel Ahmad, Duisburg (DE); Peter Adam, Nürnberg (DE); Lukas Biyikli, Ratingen (DE)

(21) Appl. No.: 19/114,502

(22) PCT Filed: Sep. 5, 2023
(86) PCT No.: PCT/EP2023/074319

§ 371 Date: Mar. 24, 2025

(30) Foreign Application Priority Data
Sep. 30, 2022 (DE) 10 2022 210 399.8

(51) Int. Cl. F02C 6/10; C01B 3/025; C01C 1/04; C25B 1/044; F02C 6/18

(52) U.S. Cl. CPC F02C 6/10; C01B 3/025; C01C 1/0405; C25B 1/044; F02C 6/18; C01B 2203/068; F05D 2220/72

(57) ABSTRACT

A system for manufacturing ammonia, having an ammonia reactor which is designed to produce ammonia (NH3) from a synthesis gas, the synthesis gas including hydrogen (H₂) and nitrogen (N2), further including an electrolizer which is designed to produce hydrogen and oxygen from water, where a compressor is fluidically connected to the electrolizer and is designed to compress the hydrogen (H2) coming from the electrolizer, wherein the compressor is designed to compress transportable hydrogen (H2).

### BACKGROUND

The invention relates to a system for manufacturing ammonia, comprising an ammonia reactor which is designed to produce ammonia (NH₃) from a synthesis gas, the synthesis gas comprising hydrogen (H₂) and nitrogen (N₂), further comprising an electrolizer which is designed to produce hydrogen (H₂) and oxygen (O₂) from water.

Moreover, the invention relates to a method for manufacturing ammonia, wherein, in an ammonia reactor, ammonia (NH₃) is produced from a synthesis gas, the synthesis gas comprising hydrogen (H₂) and nitrogen (N₂), wherein, in an electrolizer, hydrogen (H₂) and oxygen (O₂) are produced using renewable energies.

The invention proposes a concept for an ammonia system comprising an electrolizer which is operated with renewable energies, wherein cooling and heating in the system is via a chiller or a heat pump, wherein the system employs a gas turbine operated with hydrogen, wherein the gas turbine makes nitrogen available for ammonia manufacture.

The production of ammonia goes back to a known method which typically requires very much energy. According to first estimations, currently about 1% of the energy produced worldwide are required for the manufacture of ammonia.

The ammonia produced from green hydrogen is referred to as green ammonia. Green ammonia is regarded as a fast-growing energy carrier for hydrogen. Furthermore, it is used in many industrial processes, especially in fertilizers. It is estimated that approx. 50% of the green hydrogen which will be produced in the next years will be directly processed to liquid ammonia for long-distance transport of hydrogen as the liquefaction of pure hydrogen is very energy-intensive.

The largest energy and compression expenditure, in addition to the hydrogen production through electrolysis and the nitrogen production through air separation systems, is synthesis gas compression, which compresses the nitrogen-hydrogen mixture to the pressure of 150-220 bar required for the synthesis process, and the cold box, which provides the cooling energy for the liquefaction and cooling of the ammonia to approx. −33° C. at atmospheric pressure.

Typically, a pre-heating unit for heating the synthesis gas to the reaction temperature is required.

Ammonia is an important chemical used most notably in the fertilizer industry. The ammonia reaction is the catalytic reaction of hydrogen and nitrogen at high temperature and high pressure. However, the manufacture of hydrogen accounts for the largest part of energy consumption and about 90% of carbon emissions. Hydrogen is produced almost exclusively by steam reforming of fossil fuels. Most ammonia systems utilize steam reforming of natural gas to produce hydrogen and carbon dioxide. Coal, heavy fuel oil, and naphtha may also be used but have higher carbon dioxide emissions. Consequently, ammonia production with these methods causes almost 1.5% of worldwide CO₂ emissions. The nitrogen is obtained from compressed air or from an air separation system.

At present, the nitrogen and hydrogen required for the ammonia manufacture are usually compressed to the required synthesis pressure in a synthesis gas compressor. The suction pressure for this compressor is typically determined by the hydrogen pressure which in case of green ammonia applications, where electrolysis is carried out on site, is limited to the maximum starting pressure of an electrolysis system (max. 30-40 bar).

The shaft power for the compressor is delivered by a steam turbine, while the required steam is produced through the heat which is released during the ammonia synthesis. Pre-warming of the synthesis gas must be either through a fuel-fired or electricity-fired heater or through utilization of waste heat of the ammonia process, which reduces the amount of the steam produceable for the steam turbine.

Liquefaction is via a refrigerant circuit.

With commitments made to achieve net-zero emissions targets, new zero-carbon fuels such as green ammonia and green hydrogen are needed to decarbonize energy production, heat supply, traffic and industry.

It is estimated that approx. 50% of the green hydrogen which will be produced in the next years will be converted into green ammonia.

Ammonia can be used as a convenient hydrogen energy carrier and the already existing industry, which produces, stores and trades millions of tons of ammonia every year, means that the infrastructure and the technology are already existent in order to launch the hydrogen economy.

In conventional ammonia manufacture, the hydrogen gas (H₂) is obtained from steam methane reforming (SMR), the most common method for the production of hydrogen, and the nitrogen gas (N₂) is either obtained from air or from an air separation system.

Nitrogen (N₂) and hydrogen (H₂) are mixed stoichiometrically (1:3) and compressed with a syngas compressor and guided into an ammonia synthesis reactor at a pressure of 150 to 220 bar. The ammonia synthesis gas reactor operates at an operating temperature of approx. 500° C. The process is exothermal, the large amount of heat of 46 kJ/mol of ammonia is released and utilized for steam production. After the reaction, approx. 25% of ammonia are obtained as a product, the rest is returned via a circulation compressor. The produced ammonia is then liquefied through cryogenic distillation.

In the green ammonia method, the hydrogen is produced through electrolysis of water, which is a well-established method.

### SUMMARY

The invention is based on the object of providing an improved system and an improved method for manufacturing ammonia, in particular with regard to the employment of the energy required for the manufacture of the ammonia.

This object is attained by means of a system for manufacturing ammonia, comprising an ammonia reactor which is designed to produce ammonia (NH3) from a synthesis gas, the synthesis gas comprising hydrogen (H2) and nitrogen (N2), further comprising an electrolizer (2) which is designed to produce hydrogen and oxygen from water, wherein a compressor (6) is fluidically connected to the electrolizer (2) and is designed to compress the hydrogen (H2) coming from the electrolizer (2), wherein the compressor (6) is designed to compress hydrogen (H2), in particular transportable hydrogen (H2).

Moreover, the object is attained by means of a method for manufacturing ammonia, wherein, in an ammonia reactor, ammonia (NH3) is produced from a synthesis gas, the synthesis gas comprising hydrogen (H2) and nitrogen (N2), wherein, in an electrolizer, hydrogen and oxygen are produced using renewable energies, wherein the hydrogen produced in the electrolizer is compressed in a compressor.

A new concept for the manufacture of green ammonia is therefore proposed. The present solution provides for the electrolizer (alternative spelling: electrolyzer) to be set up in a remote area and for the hydrogen to be able to be transported over a few hundred kilometers via a pipeline.

The electrolizer absorbs electrical energy from wind power or photovoltaics and produces hydrogen and oxygen. These gases are produced by the electrolizer at a pressure of 1-40 bar.

Cooling water is required to cool an electrolizer, which is difficult to procure in remote or desert-like areas.

According to the invention, it is proposed to expand the compressed oxygen directly in an expansion turbine, which is used for cooling after the expansion.

According to the invention, it is proposed to use a heat pump circuit, the heat of which is used to raise the oxygen temperature before it is expanded in a generator-coupled expansion turbine. In a condenser, all the latent heat of the refrigerant is utilized to convert the water into steam, and the refrigerant is simultaneously condensed.

The pressurized steam may also be utilized to produce electric current. In addition, the refrigerant of the heat pump is expanded in a J-T valve or hot expander, and the enthalpy of the refrigerant may be converted into mechanical or electrical energy, respectively. The biphasic refrigerant mixture cools the hot water exiting the electrolizer and is simultaneously evaporated by extracting heat from the hot water before it enters the heat pump compressor.

At the site of the ammonia system, nitrogen (N₂) and hydrogen (H₂) are required as a starting material, which is mixed stoichiometrically at a ratio of 1:3. Nitrogen (N₂) is normally supplied via an air separation system or from the air, while hydrogen is mainly delivered from steam methane reforming.

Advantageously, the invention does not require any air separation system for nitrogen (N₂).

According to the invention, the hydrogen (H₂) is produced in an electrolizer, since it is one of the starting materials for ammonia, and is delivered to the site of the ammonia system via a pipeline. For nitrogen production, a gas turbine is used, which is operated with hydrogen and drives a syngas compressor. The exhaust gas of this gas turbine consists mainly of hot steam and nitrogen, which is separated in a condenser and later absorbed in an absorber or a PSA unit. The condensed water is obtained in the condenser unit. The condensed water can be pumped and heated with the exhaust gas heat from the gas turbine and is later expanded in a steam turbine which produces additional electricity.

The nitrogen produced from the exhaust gas is separated from the steam and absorbed in the absorber or PSA unit. Subsequently, it is compressed and stoichiometrically mixed with compressed hydrogen to produce a synthesis gas mixture. The synthesis gas mixture is compressed to the required process pressure in a synthesis gas compressor.

The advantages of the system according to the invention and the method according to the invention include, but are not limited to:
More efficient, environmentally friendly and economical processes for green hydrogen and green ammonia;
The integration of gas turbine exhaust gases operated with hydrogen (H₂) enables the production of nitrogen (N₂) and green electrical/mechanical drive energy as well as water for electrolysis;
The utilization of pressurized oxygen (O₂) for the conversion into electricity increases overall efficiency and supports the operation of the system with fluctuating renewable energy; and
More efficient, environmentally friendly and economical processes for green hydrogen and green ammonia.

The characteristics, features and advantages of this invention described above, as well as the manner in which these are achieved, will be more clearly and fully understood in connection with the following description of the exemplary embodiments, which will be explained in more detail in connection with the drawings.

Identical components or components with the same function are marked with the same reference numerals.

### BRIEF DESCRIPTION OF THE DRAWINGS

Exemplary embodiments of the invention are described hereinafter with reference to the drawings. These are not intended to represent the exemplary embodiments to scale; rather, where useful for explanation, the drawing is executed in a schematic and/or slightly distorted form. With regard to additions to the teachings immediately visible in the drawing, reference is made to the relevant prior art.

In the drawings:

FIGS. 1A and 1B show a schematic representation of a system for the production of ammonia.

### DETAILED DESCRIPTION

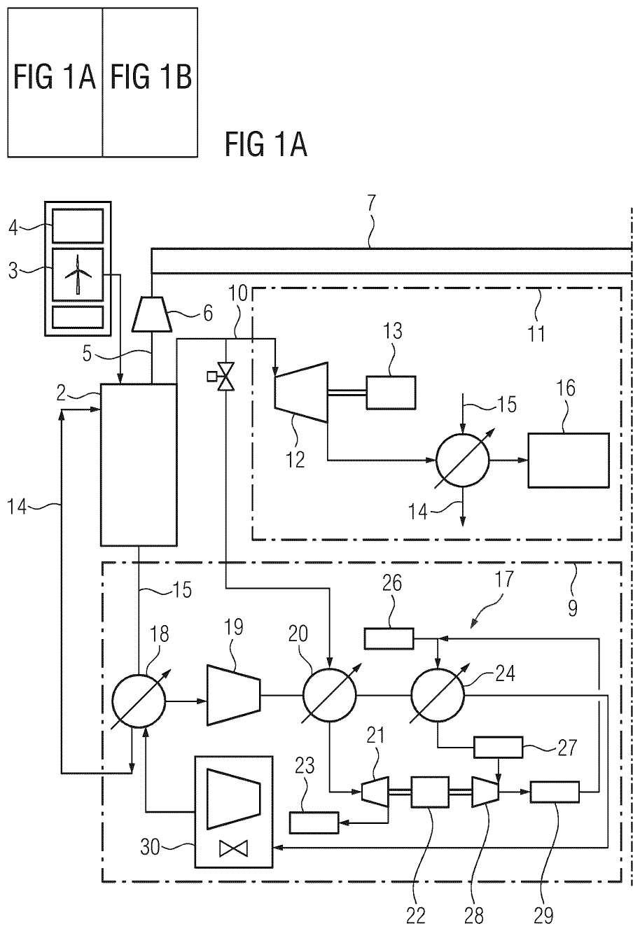

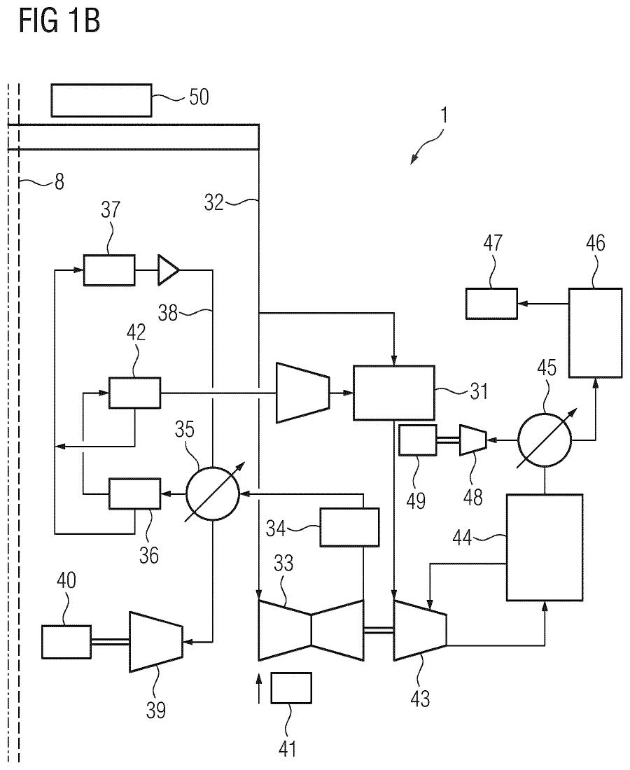

FIGS. 1A and 1B shows a schematic representation of a system 1 for the production of ammonia.

The system 1 comprises an electrolizer 2, which is also referred to as an electrolizer 2. The electrolizer 2 is designed to produce hydrogen (H₂) and oxygen (O₂). For this purpose, water (H₂O) is split into its elements hydrogen (H₂) and oxygen (O₂) using a lot of electrical energy produced from wind power 3, photovoltaics 4 or any other renewable energies.

Via a line 5, the hydrogen (H₂) thus produced is directed to a compressor 6, where the hydrogen is compressed such that it can be conveyed over an extensive distance in a pipeline 7. Therefore, the compression in the compressor 6 is under high pressure. The dashed line 8 symbolically represents the spatial separation between the production of the hydrogen and the ammonia manufacture 8. The separation between the production of the hydrogen and the ammonia manufacture 8 may be several kilometers.

In a first option 11, the pressurized oxygen (O₂) is supplied to an expander 12 via a line 10. In the expander 12, the pressure energy of the oxygen (O₂) is converted into mechanical energy, wherein the mechanical energy may be used to drive a generator 13.

The electrolizer 2 requires cooling for operation. For this purpose, a cooling line 14 with cooled water as coolant is supplied to the electrolizer 2 and the water heated in the electrolizer 2 is directed out of the electrolizer 2 via another cooling line 15.

In the first option 11, the hot water is supplied to a heat exchanger 16, where the thermal energy of the hot water is transferred to the cold oxygen (O₂) coming from the expander. The oxygen (O₂) heats up in the process. The water, on the contrary, cools down and is then again supplied to the electrolizer 2 via the line 14.

The oxygen (O₂) coming out of the heat exchanger may then be used for further energy production or discharged into the atmosphere.

In a second option 9, the heated water from the line 15 is supplied as a heat source to a heat pump circuit 17. For this purpose, the water heated in the electrolizer 2 arrives at a heat exchanger 18 via the line 15. There, the thermal energy of the water is used to heat the refrigerant located in the heat pump circuit 17. The water cools down and is again supplied to the electrolizer 2 as cooled cooling water via the line 14.

Downstream of the heat exchanger 18, the refrigerant arrives at a compressor 19 or compressing device 19. There, the temperature and pressure of the refrigerant are increased. Downstream of the compressor 19, the refrigerant flows through a heat exchanger 20, with the oxygen (O₂) produced in the electrolizer 2 flowing therethrough. The oxygen (O₂) heated in the heat exchanger 20 is supplied to an expander 21 and may be employed there for producing electrical energy via a generator 22. The prior supply of thermal energy causes more electrical energy to be produceable than in the first option. Cooled oxygen 23 comes out of the expander 21.

Downstream of the heat exchanger 20, the refrigerant arrives at a further heat exchanger 24, where the thermal energy of the refrigerant is transferred to water 26 which comes via a line 25. The heat exchanger 24 is designed such that the water is converted into steam and the steam 27 is supplied to a steam turbine 28. The steam turbine 28 may then drive the same generator 22 and thus produce electrical energy. The water 29, which is condensed into water again downstream of the steam turbine 28, may again be supplied to the heat exchanger 24.

Downstream of the heat exchanger 24, the refrigerant flows to an expansion device 30, which may be either a Joule-Thomson valve (J-T valve) or an expander, wherein the temperature and pressure of the refrigerant are reduced. Downstream of the expansion device 30, the refrigerant again flows to the heat exchanger 18, whereby the heat pump circuit is then closed.

For the ammonia method, nitrogen (N₂) and hydrogen (H₂) are required as starting materials, which are mixed stoichiometrically at a ratio of 1:3. In a conventional system, the nitrogen (N₂) is supplied from an air separation system or from the air, while the hydrogen (H₂) mainly originates from steam methane reforming.

Via the pipeline 7, the hydrogen arrives at a mixing chamber 31, where the hydrogen (H₂) and the nitrogen (N₂) are mixed to form the synthesis gas.

Via a line 32, part of the hydrogen (H₂) from the pipeline 7 is supplied to a gas turbine 33 operable with hydrogen (H₂). The hot exhaust gas flowing out of the gas turbine 33 contains a mixture 34 of nitrogen (N₂), water (H₂O), hydrogen (H₂), nitrogen oxides (NOx) and oxygen (O₂). The hot exhaust gas is supplied to a heat exchanger 35. Downstream of the heat exchanger 35, the exhaust gas flows to a condenser 36, where water from the exhaust gas condenses. Via a line 38, the water 37 is then directed through the heat exchanger, where it is converted into steam. Subsequently, the steam is supplied to a steam turbine 39, where the thermal energy of the steam is converted into mechanical energy, wherein electrical energy is produced via a generator 40.

Air 41, in particular ambient air, is supplied to the gas turbine 33.

Part of the exhaust gas flows through an absorber 42 or a pressure swing adsorption (PSA) 42, where the nitrogen (N₂) is branched off from the exhaust gas and flows to the mixing chamber 31 with the synthesis gas. The synthesis gas flows through a compressor 43, which is driven by the gas turbine, to the ammonia reactor 44. The hot ammonia created in the ammonia reactor 44 is cooled via a heat exchanger 45 and supplied to a storage device 47 via a cooling unit 46. The heat created in the heat exchanger 45 may be used for steam production and a steam turbine 48 may be operated with a generator 49.

The separated nitrogen (N₂) from the GT exhaust gas is stoichiometrically mixed with the hydrogen (H₂) from the electrolysis system in order to produce the required synthesis gas mixture for ammonia synthesis.

The synthesis gas is supplied in the ammonia reactor 44. The synthesis gas comprises hydrogen (H₂) and nitrogen (N₂). The hydrogen (H₂) and nitrogen (N₂) react in the electrolizer 2 according to the chemical reaction

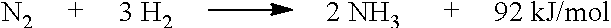

This chemical reaction is a strongly exothermal reaction, i.e., the ammonia NH₃ created in the ammonia reactor has a comparably high temperature, wherein this high temperature is used according to the invention for producing steam for expansion in the steam turbine 48 to produce electrical energy in the generator 49.

Here, a detailed representation of the ammonia reactor 44 is dispensed with.

1. A system for manufacturing ammonia, comprising an ammonia reactor which is designed to produce ammonia (NH₃) from a synthesis gas, the synthesis gas comprising hydrogen (H₂) and nitrogen (N₂); and
further comprising an electrolizer which is designed to produce hydrogen and oxygen from water,
wherein
a compressor which is fluidically connected to the electrolizer and is designed to compress the hydrogen (H₂) coming from the electrolizer, and
wherein the compressor is designed to compress hydrogen (H₂).

2. The system according to claim 1, wherein the compressed hydrogen (H₂) is suitable for transport in a pipeline.

3. The system according to claim 1, wherein the electrolizer is operated with renewable energies.

4. The system according to claim 1, further comprising a gas turbine operated with hydrogen (H₂), wherein the hydrogen (H₂) produced from the electrolizer is mixed with the nitrogen (N2) produced from an exhaust gas of the gas turbine to produce the synthesis gas.

5. The system according to claim 4, further comprising a heat exchanger which is designed to produce steam from a thermal energy of the exhaust gas of the gas turbine, wherein a steam turbine is provided which is charged with the steam from the heat exchanger.

6. The system according to claim 5, further comprising a generator which is coupled to the steam turbine in a torque-transmitting manner.

7. The system according to claim 6, further comprising a separation unit-which is designed to separate an exhaust gas from the gas turbine into nitrogen and water, wherein the nitrogen is employed for the synthesis gas, wherein the water is supplied to the heat exchanger.

8. The system according to claim 1, further comprising an oxygen line for oxygen which was obtained from the electrolizer, further comprising an expander, wherein the oxygen from the oxygen line is fluidically connected to the expander, wherein, in the expander, a pressure energy of the oxygen from the oxygen line is converted into mechanical energy.

9. The system according to claim 8, further comprising a heat exchanger which is designed such that the oxygen flowing out of the expander cools a coolant of the electrolysis.

10. The system according claim 1, wherein the electrolizer is coolable with a coolant, wherein the system comprises a heat pump circuit which is designed to cool the coolant.

11. The system according to claim 10, further comprising a heat exchanger which is fluidically connected to the oxygen line, wherein the heat exchanger is designed such that a thermal energy of the coolant located in the heat pump circuit is transferrable to the oxygen.

12. A method for manufacturing ammonia, wherein, in an ammonia reactor, ammonia (NH3) is produced from a synthesis gas, the synthesis gas comprising hydrogen (H2) and nitrogen (N2), wherein, in an electrolizer, hydrogen and oxygen are produced using renewable energies, wherein the hydrogen produced in the electrolizer is compressed in a compressor.

13. The method according to claim 12, wherein the hydrogen compressed in the compressor is employed for transport.

14. The method according to claim 12, wherein an expander is used which is operated with a heated oxygen from a heat exchanger.

15. The method according to claim 12, wherein a generator is employed which is operated with an expander, wherein the generator is designed to produce electrical energy.

16. The method according to claim 12, wherein a separation unit is used with which an exhaust gas from a gas turbine is separated into nitrogen and water.

17. The method according to claim 12, wherein a coolant is used for cooling the electrolizer, wherein the coolant is cooled down with a heat pump circuit.
